(19) United States
(12) Patent Application Publication
(10) Pub. No.: US 2026/0086630 A1
(43) Pub. Date: Mar. 26, 2026

(54) HEAD ROTATION DETERMINATION BASED ON ROUTE TRACING

(71) Applicant: Apple Inc., Cupertino, CA (US)

(72) Inventor: Gregory LUTTER, Boulder Creek, CA (US)

(21) Appl. No.: 19/312,729

(22) Filed: Aug. 28, 2025

Related U.S. Application Data
(60) Provisional application No. 63/699,731, filed on Sep. 26, 2024.

(51) Int. Cl. G06F 3/01; G02B 27/00; G02B 27/01

(52) U.S. Cl. CPC G06F 3/012; G02B 27/0093; G02B 27/0172; G02B 27/0179; G02B 2027/0187

(57) ABSTRACT

Some examples of the disclosure are directed to a method performed at an electronic device configured to track a first vector indicative of an orientation of the electronic device. In some examples, the electronic device tracks a second vector indicative of a predicted motion path of the electronic device. In some examples, the device detects a difference between the first vector and the second vector. In some examples, and in accordance with a determination that one or more first criteria are satisfied, the electronic device determines the difference as a head rotation input and performs an action in accordance with the head rotation input.

### CROSS REFERENCE TO RELATED APPLICATIONS

This application claims the benefit of U.S. Provisional Application No. 63/699,731, filed Sep. 26, 2024, the entire disclosure of which is herein incorporated by reference for all purposes.

### FIELD OF THE DISCLOSURE

This relates generally to systems and methods for head rotation determination based on route tracing.

### BACKGROUND OF THE DISCLOSURE

Some computer graphical environments provide two-dimensional and/or three-dimensional environments where at least some objects displayed for a user's viewing are virtual and generated by a computer. For example, a plurality of content items is often presented in computer graphical environments as a scrollable list. Providing efficient methods for scrolling a scrollable list in a computer graphical environment can improve user experience.

### SUMMARY OF THE DISCLOSURE

Some examples of the disclosure are directed to a method of detecting head rotation based on a determination of route tracing. The method is performed at an electronic device comprising one or more displays and one or more input devices. In some examples, the electronic device tracks, using the one or more input devices, a first vector indicative of an orientation of the electronic device. In some examples, the electronic device tracks, using the one or more input devices, a second vector, different from the first vector, indicative of a predicted motion path of the electronic device. In some examples, the device detects a difference between the first vector and the second vector. In some examples, and in accordance with a determination that one or more first criteria are satisfied, the electronic device determines the difference as a head rotation input. In some examples, the one or more first criteria include a criterion that is satisfied when the difference between the first vector and the second vector is greater than a threshold. In some examples, the electronic device performs an action in accordance with the head rotation input satisfying one or more second criteria. In some examples, and in accordance with a determination that the one or more first criteria are not satisfied, the electronic device forgoes determining the difference as the head rotation input and forgoing performing the action.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIG. 3A shows a user wearing a head-mounted device and its display while the user faces in the forward direction in a three-dimensional environment according to some examples of the disclosure.

FIG. 3B shows the same user as in FIG. 3A, but now with a rotation of the head and the respective change in display on the head-mounted device according to some examples of the disclosure.

FIG. 4A illustrates a user wearing a head-mounted device while in straight forward motion in a three-dimensional environment and the display on the device; the head of the user aligns with the way their body is facing according to some examples of the disclosure.

FIG. 4B shows the same user as FIG. 4A, but now moving in a different direction than the way the device and the user's head are facing according to some examples of the disclosure.

FIG. 5A exemplifies a user wearing a head-mounted device and traveling around a curve according to some examples of the disclosure.

FIG. 5B shows the actual travel curve versus the predicted motion travel curve from FIG. 5A according to some examples of the disclosure.

FIG. 5C shows the same user traveling around a corner as FIG. 5A, however a head movement input is detected at the end of the travel curve according to some examples of the disclosure.

FIGS. 6A and 6B illustrate example actions performed on the head-mounted device when a head rotation input is detected according to some examples of the disclosure.

FIGS. 7 and 8 illustrate example methods for head rotation determination based on route tracing according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Some examples of the disclosure are directed to a method. The method is performed at an electronic device comprising one or more displays and one or more input devices. In some examples, the electronic device tracks, using the one or more input devices, a first vector indicative of an orientation of the electronic device. In some examples, the electronic device tracks, using the one or more input devices, a second vector, different from the first vector, indicative of a predicted motion path of the electronic device. In some examples, the device detects a difference between the first vector and the second vector. In some examples, and in accordance with a determination that one or more first criteria are satisfied, the electronic device determines the difference as a head rotation input. In some examples, the one or more first criteria include a criterion that is satisfied when the difference between the first vector and the second vector is greater than a threshold. In some examples, the electronic device performs an action in accordance with the head rotation input satisfying one or more second criteria. In some examples, and in accordance with a determination that the one or more first criteria are not satisfied, the electronic device forgoes determining the difference as the head rotation input and forgoing performing the action.

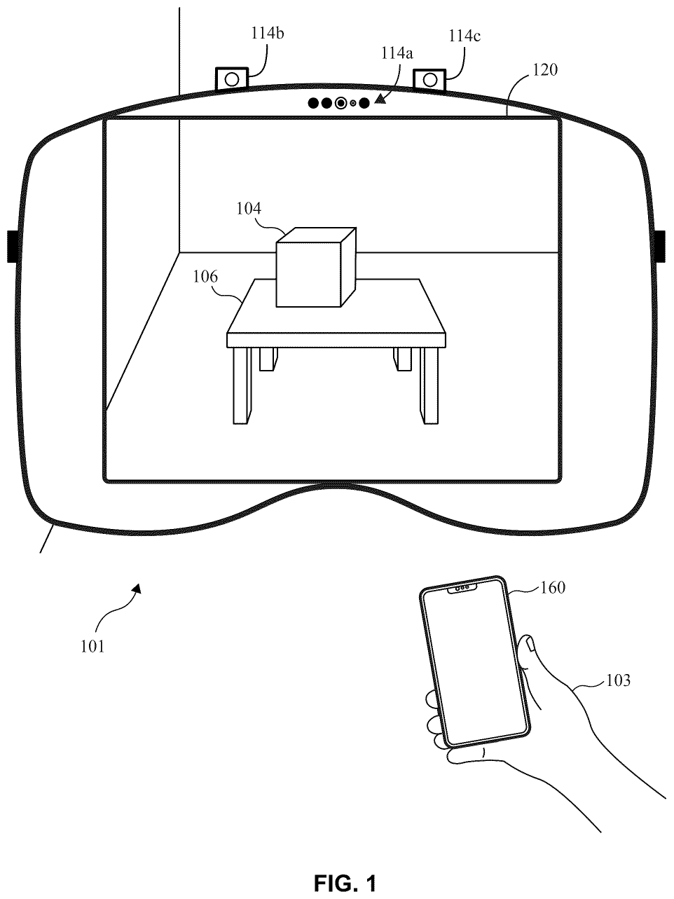

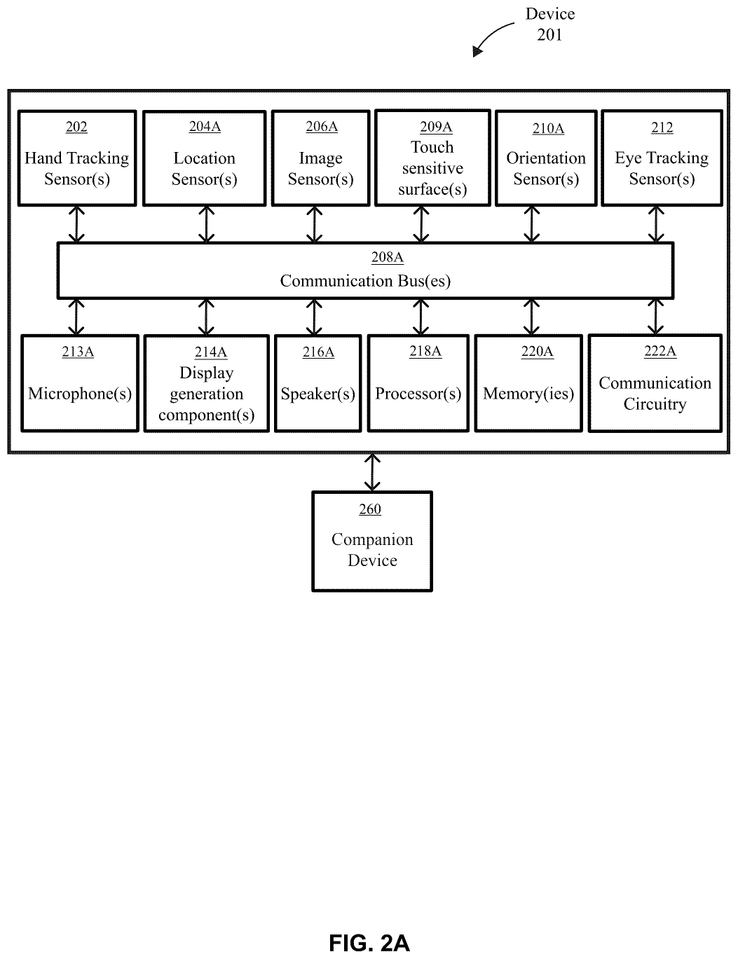

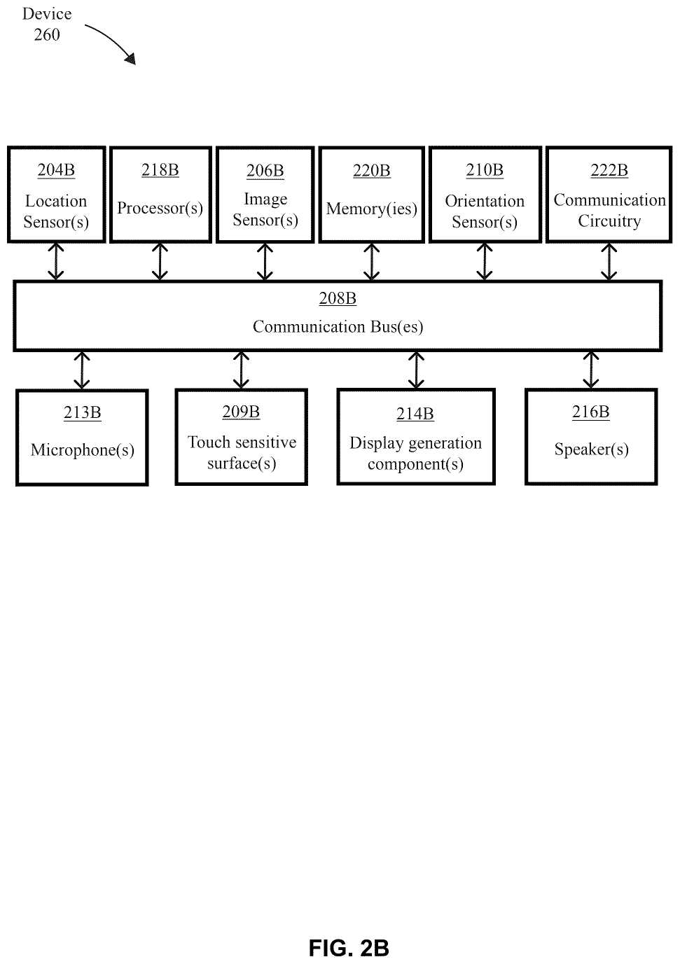

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 is configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 is smaller than the field of view of the user's eyes. In some examples, electronic device 101 is an optical see-through device in which display 120 is a transparent or translucent display through which portions of the physical environment are directly viewed. In some examples, display 120 is included within a transparent lens and may overlap all or only a portion of the transparent lens. In other examples, electronic device is a video-passthrough device in which display 120 is an opaque display configured to display images of the physical environment captured by external image sensors 114b and 114c. While a single display 120 is shown, it should be appreciated that display 120 includes a stereo pair of displays.

In some examples, in response to a trigger, the electronic device 101 is configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, the electronic device 101 is configured to communicate with a second electronic device, such as a companion device. For example, as illustrated in FIG. 1, the electronic device 101 is in communication with electronic device 160. In some examples, the electronic device 160 corresponds to a mobile electronic device, such as a smartphone, a tablet computer, a smart watch, or other electronic device. Additional examples of electronic device 160 are described below with reference to the architecture block diagram of FIG. 2B. In some examples, the electronic device 101 and the electronic device 160 are associated with a same user. For example, in FIG. 1, the electronic device 101 is positioned (e.g., mounted) on a head of a user and the electronic device 160 is positioned near electronic device 101, such as in a hand 103 of the user (e.g., the hand 103 is holding of the electronic device 160), and the electronic device 101 and the electronic device 160 are associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment includes interaction with one or more user interface objects in the three-dimensional environment. For example, initiation of display of the object in the three-dimensional environment can include interaction with one or more virtual options/affordances displayed in the three-dimensional environment. In some examples, a user's gaze is tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance is selected using hand-tracking input detected via an input device in communication with the electronic device. In some examples, objects displayed in the three-dimensional environment is moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 and/or electronic device 260 include one or more electronic devices. For example, the electronic device 201 is a portable device, an auxiliary device in communication with another device, a head-mounted display, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes various sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), one or more display generation components 214A, optionally corresponding to display 120 in FIG. 1, one or more speakers 216A, one or more processors 218A, one or more memories 220A, and/or communication circuitry 222A. One or more communication buses 208A are optionally used for communication between the above-mentioned components of electronic devices 201.

Additionally, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices. For example, as indicated in FIG. 2A, the electronic device 260 functions as a companion device to the electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

One or more processors 218A, 218B include one or more general processors, one or more graphics processors, and/or one or more digital signal processors. In some examples, memory 220A or 220B is a non-transitory computer-readable storage medium (e.g., flash memory, random access memory, or other volatile or non-volatile memory or storage) that stores computer-readable instructions configured to be executed by one or more processors 218A, 218B to perform the techniques, processes, and/or methods described below. In some examples, memory 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, one or more display generation components 214A, 214B includes multiple displays. In some examples, one or more display generation components 214A, 214B can include a display with touch capability (e.g., a touch screen), a projector, a holographic projector, a retinal projector, a transparent or translucent display, etc. In some examples, electronic devices 201 and 260 include one or more touch-sensitive surfaces 209A and 209B, respectively, for receiving user inputs, such as tap inputs and swipe inputs or other gestures. In some examples, one or more display generation components 214A, 214B and one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally includes one or more image sensors 206A and 206B, respectively. One or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. One or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. One or more image sensors 206A, 206B also optionally include one or more cameras configured to capture movement of physical objects in the real-world environment. One or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201, 260 uses CCD sensors, event cameras, and depth sensors in combination to detect the physical environment around electronic device 201, 260. In some examples, one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201, 260 uses one or more image sensors 206A, 206B to detect the position and orientation of electronic device 201, 260 and/or one or more display generation components 214A, 214B in the real-world environment. For example, electronic device 201, 260 uses one or more image sensors 206A, 206B to track the position and orientation of one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses one or more microphones 213A, 213B to detect sound from the user and/or the real-world environment of the user. In some examples, one or more microphones 213A, 213B includes an array of microphones (a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201A and/or one or more display generation components 214A and a location of electronic device 260 and/or one or more display generation components 214B, respectively. For example, one or more location sensors 204A, 204B can include a global positioning system (GPS) receiver that receives data from one or more satellites and allows electronic device 201, 260 to determine the device's absolute position in the physical world.

Electronic devices 201 and 260 include one or more orientation sensors 210A and 210B, respectively, for detecting orientation and/or movement of electronic device 201 and/or one or more display generation components 214A and orientation and/or movement of electronic device 260 and/or one or more display generation components 214B, respectively. For example, electronic device 201, 260 uses one or more orientation sensors 210A, 210B to track changes in the position and/or orientation of electronic device 201, 260 and/or one or more display generation components 214A, 214B, such as with respect to physical objects in the real-world environment. One or more orientation sensors 210A, 210B optionally include one or more gyroscopes and/or one or more accelerometers.

Electronic device 201 includes one or more hand tracking sensors 202 and/or one or more eye tracking sensors 212 (and/or other one or more body tracking sensors, such as leg, torso and/or one or more head tracking sensors), in some examples. One or more hand tracking sensors 202 are configured to track the position/location of one or more portions of the user's hands, and/or motions of one or more portions of the user's hands with respect to the extended reality environment, relative to the one or more display generation components 214A, and/or relative to another defined coordinate system. One or more eye tracking sensors 212 are configured to track the position and movement of a user's gaze (eyes, face, or head, more generally) with respect to the real-world or extended reality environment and/or relative to the one or more display generation components 214A. In some examples, one or more hand tracking sensors 202 and/or one or more eye tracking sensors 212 are implemented together with the one or more display generation components 214A. In some examples, the one or more hand tracking sensors 202 and/or one or more eye tracking sensors 212 are implemented separate from the one or more display generation components 214A. In some examples, electronic device 201 alternatively does not include one or more hand tracking sensors 202 and/or one or more eye tracking sensors 212. In some such examples, the one or more display generation components 214A may be utilized by the electronic device 260 to provide an extended reality environment and utilize input and other data gathered via the other one or more sensors (e.g., the one or more location sensors 204A, one or more image sensors 206A, one or more touch-sensitive surfaces 209A, one or more motion and/or orientation sensors 210A, and/or one or more microphones 213A or other audio sensors) of the electronic device 201 as input and data that is processed by the one or more processors 218B of the electronic device 260. Additionally or alternatively, electronic device 201 optionally does not include other components shown in FIG. 2B, such as location sensors 204B, image sensors 206B, touch-sensitive surfaces 209B, etc. In some such examples, the one or more display generation components 214A may be utilized by the electronic device 260 to provide an extended reality environment and the electronic device 260 utilize input and other data gathered via the one or more motion and/or orientation sensors 210A (and/or one or more microphones 213A) of the electronic device 201 as input.

In some examples, the one or more hand tracking sensors 202 (and/or other one or more body tracking sensors, such as leg, torso and/or one or more head tracking sensors) can use one or more image sensors 206 (e.g., one or more IR cameras, three-dimensional cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that such tracking does not require the user to touch, hold or wear any sort of beacon, sensor, or other marker.

In some examples, one or more eye tracking sensors 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards example systems and methods for head rotation input determination. In some examples, electronic devices receive inputs from the user to perform actions on the electronic devices. For example, inputs can include gestures such as touch gestures on a touch sensitive surface or other gestures performed using portions of the body. As non-limiting examples, hand gestures or head rotation of a user can be used and/or detected as input. For example, when a user is wearing a head-mounted device, the yaw rotation of the user's head can be used as an input to control scrolling of content on a user interface. As another example, when a user is wearing a head-mounted device, the yaw rotation of the user's head can be used as an input to control a non-display function such as controlling music playback (e.g., volume, play/pause, fast-forward/rewind, skip forward/backward). Although primarily described in terms of yaw rotation of the head, head rotation is not so limited. In some examples, pitch rotation or roll rotation can be used as inputs to control operation of the head-mounted device or another device in communication with the head-mounted device. In some examples, as used herein, head movement refers to the rotational movement of the head of the user (e.g., about the neck of the user) relative to the torso of the user in the three-dimensional environment.

One challenge with head movement as an input is differentiating between intentional and unintentional head movement. For example, the natural movement of the head (e.g., while stationary) can be differentiated from intentional movement of the head using one or more criteria. For example, the amount of movement (e.g., defined in terms of a rotation angle), the direction of movement (e.g., defined in terms of a yaw rotation), and/or the speed of the movement (e.g., defined in terms of angular velocity within a threshold range of angular velocities), can be used differentiate intentional head movement from unintentional head movement. Differentiating between intentional and unintentional head movement can be even more complicated during locomotion within an environment (often referred to simply as motion). For example, when the user is walking relative to a three-dimensional environment, the unintentional head rotation can increase compared to such rotation when the user is stationary, and/or a non-linear route of locomotion may induce head rotations. Additionally, when the user is walking, the some or all of the body (e.g., including the head and/or torso) of the user changes directions, which may result in absolute head rotation being misinterpreted (without a consideration of the impact of locomotion on the body) as intentional head rotation input, even when the user's head remained unrotated relative to the torso. As a result, locomotion can increase the likelihood of falsely determining an unintended head rotation as an intended input. To improve performance, the system and method of determining whether head rotation is intentional or unintentional can consider locomotion (e.g., to filter out head movement caused by locomotion). For example, the route of motion can be determined and/or used to predict a motion vector. A determination of head movement can be determined using the predicted motion vector, such as by comparing the forward vector of a head-mounted device with the predicted motion vector. Using the difference of the forward vector of a head-mounted device relative to the predicted motion vector, instead of relative to a prior forward vector of a head-mounted device, to detect a head rotation input or lack thereof can improve performance because the predicted motion vector accounts for the unintentional head rotation due to the movement relative to the prior forward vector of the head-mounted device. The reduced incidence of unintended head movement being detected as head rotation input can improve user experience by reducing unintended inputs that may cause unintended actions on the electronic device.

In some examples, the electronic device described herein may be any device, including a head-mounted device. For example, electronic device may be either electronic device 201 or 260. In some examples, the electronic device comprises one or more displays, which can be any type of display described herein, including a touch screen display capable of receiving user inputs. Furthermore, in some examples, the electronic device comprises one or more input devices. Some non-limiting examples include a touch screen display, a microphone, a camera, a controller, or anything similar and mentioned in relation to FIGS. 1 and 2.

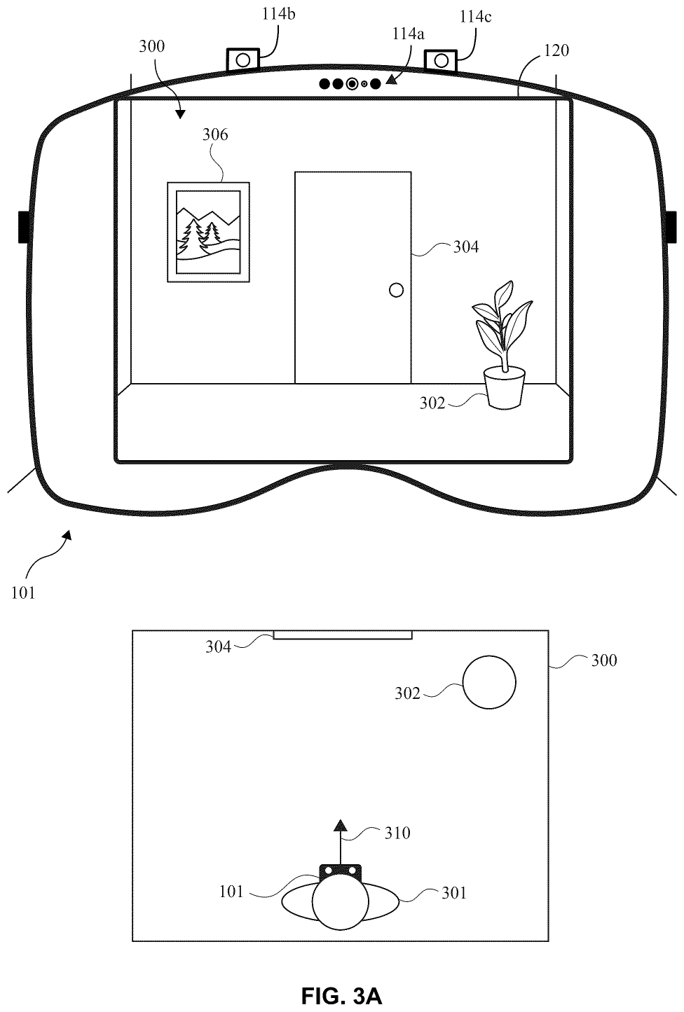

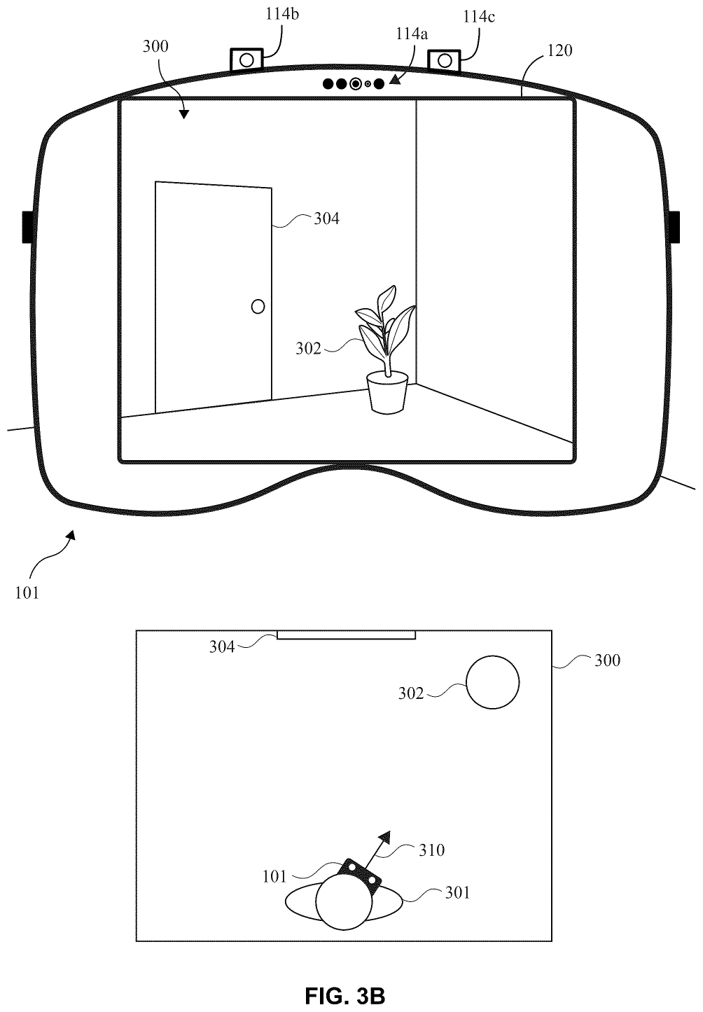

In FIGS. 3A and 3B, a top view of user 301 wearing an electronic device 101 (e.g., a head-mounted device) and the display 120 of electronic device 101 are shown. Electronic device 101 optionally displays a three-dimensional environment 300 via the display 120. Three-dimensional environment 300 optionally includes representations of physical objects of a physical environment of the electronic device 101 that is in the field of view of the device from a current viewpoint of electronic device 101. For example, as shown in FIG. 3A, the physical environment of the electronic device 101 includes door 304 and houseplant 302. Accordingly, in some examples, the three-dimensional environment 300 includes a representation of the door 304 and a representation of the houseplant 302, which correspond to computer-generated representations (e.g., images) of the door 304 and the houseplant captured by image sensors 114b and 114c (e.g., cameras of the electronic device 101) or see-through representations that are visible via a transparent portion of the display 120. In FIG. 3A, user 301 is stationary and looks straight ahead; their head is aligned with the position of their body. For example, a forward direction of the head of the user is aligned with a forward direction of a torso of the user (e.g., a vector perpendicular to a line through the user's shoulders). On the other hand, FIG. 3B illustrates the torso of the user 301 still facing forward (e.g., as in FIG. 3A) and being stationary, but with a head rotation to the right in the top view, and the new, updated view of the three-dimensional environment 300 via the display 120, which is based on an updated viewpoint of the electronic device 101 as a result of the head rotation.

In some examples, the electronic device 101 tracks a first vector 310 indicative of an orientation of the electronic device 101 using the one or more input devices. An orientation of the electronic device 101 can be defined as a frame of reference of the electronic device to determine which direction in the environment is “front” relative to electronic device 101. In some examples, as indicated in the top view in FIGS. 3A and 3B, the first vector 310 may be defined as extending away from a center of the viewpoint of the electronic device 101, such as a center of the display 120. In some examples, the determination of the first vector is independent of a direction of a gaze of the user 301 (e.g., a direction in which the user 301 is looking). In some examples, electronic device 101 can track the first vector 310 using its one or more input devices, such as a camera or any other input device mentioned herein. In a non-limiting example, the camera or other input device detects a change or movement of the first vector 310 by detecting a movement of the physical objects in the three-dimensional environment 300 relative to electronic device 101. The movement of the physical objects indicates a new direction is now considered the forward direction for the head-mounted device. In some examples, the first vector 310 points in the forward direction in the three-dimensional environment 300 relative to the electronic device 101. For example, as shown in the top view in FIG. 3A, when the electronic device 101 is a head-mounted device, the orientation of the electronic device 101 and user 301 are the same when the user 301 is stationary and looking forward. In FIG. 3A, the orientation of the electronic device 101 is represented by first vector 310, as similarly discussed above.

However, in some examples, when a user 301 rotates their head in the yaw direction and their torso remains stationary, as exemplified in the top view in FIG. 3B, the orientation of the electronic device 101 will change to correspond to the direction the head of user 301 is now facing. Thus, the first vector 310 of the electronic device 101 is updated in accordance with the updated orientation of the electronic device 101. Head rotation of user 301 causes the overall orientation of the electronic device 101 to change because its forward direction relative to the three-dimensional environment 300 is now different than previously detected. As shown on the display 120 in FIGS. 3A and 3B, a change in the display 120 visually indicates a change in first vector 310. For example, in FIG. 3A, while the user 301 is standing still and viewing the three-dimensional environment 300 via the display 120, one or more real-world items, such as door 304 (e.g., physical door) or houseplant 302, are visible in the field of view of the three-dimensional environment 300 from the current viewpoint of the electronic device 101. These items are detected to be there by the head-mounted device (e.g., electronic device 101). When user 301 turns their head and keeps their body still, as discussed above with reference to FIG. 3B, display 120 updates the view of the three-dimensional environment 300, which causes door 304 and houseplant 302 to be shifted/translated to different locations relative to the updated viewpoint of the electronic device 101. In some examples, the updated display of door 304 and houseplant 302 in the three-dimensional environment 300 relative to the updated viewpoint of the electronic device 101 visually indicates and/or corresponds to a rotation of the head of the user 301 in the yaw direction, and thus a change or movement in the first vector 310. As alluded to above, in the examples of FIGS. 3A and 3B, when the head rotation, and thus the first vector 310, is tracked, a body orientation (e.g., torso orientation) of user 301 stays the same. As discussed below, however, body orientation, or which way the user's body (e.g., torso) faces, is challenging to track while also tracking head movement.

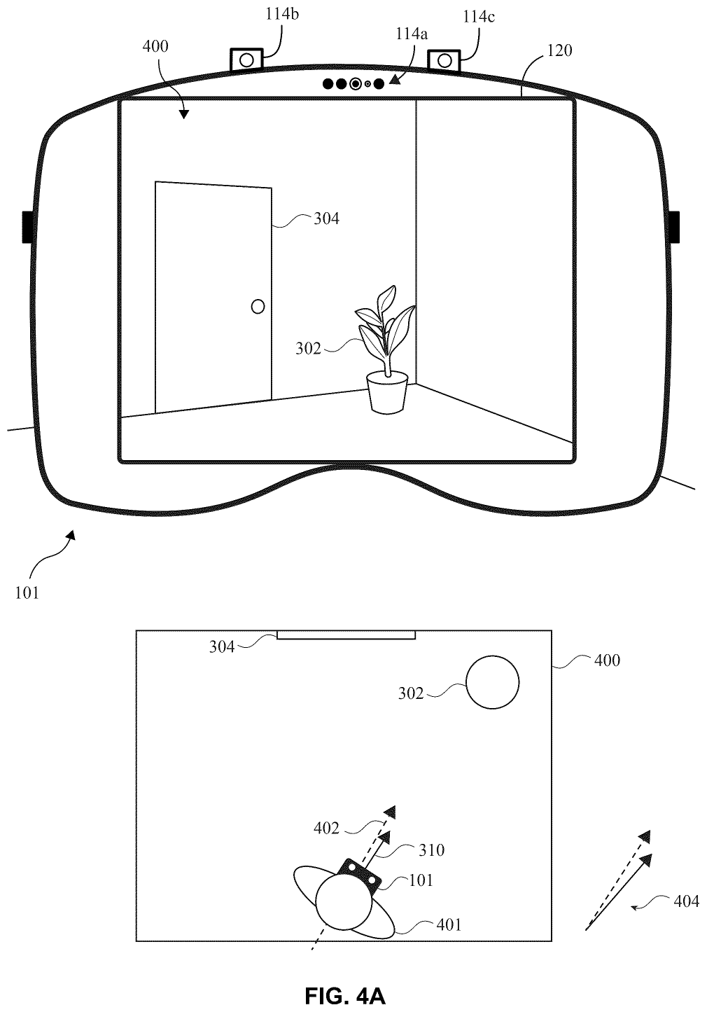

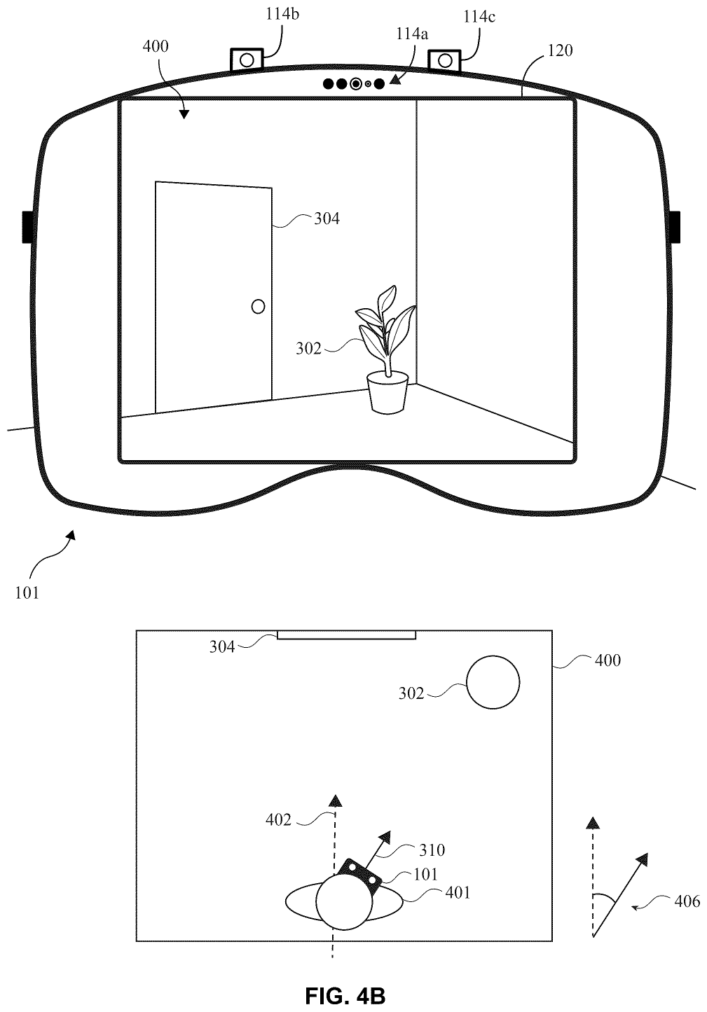

FIGS. 4A and 4B exemplify user 401 and display 120 while user 401 is in locomotion. In FIG. 4A, the head of user 401 faces the same direction in which the body of the user 401 is moving. In FIG. 4B, the head of user 401 is facing a different direction than a direction in which the body of the user is moving (optionally thus illustrating a head rotation of the user 401 during movement).

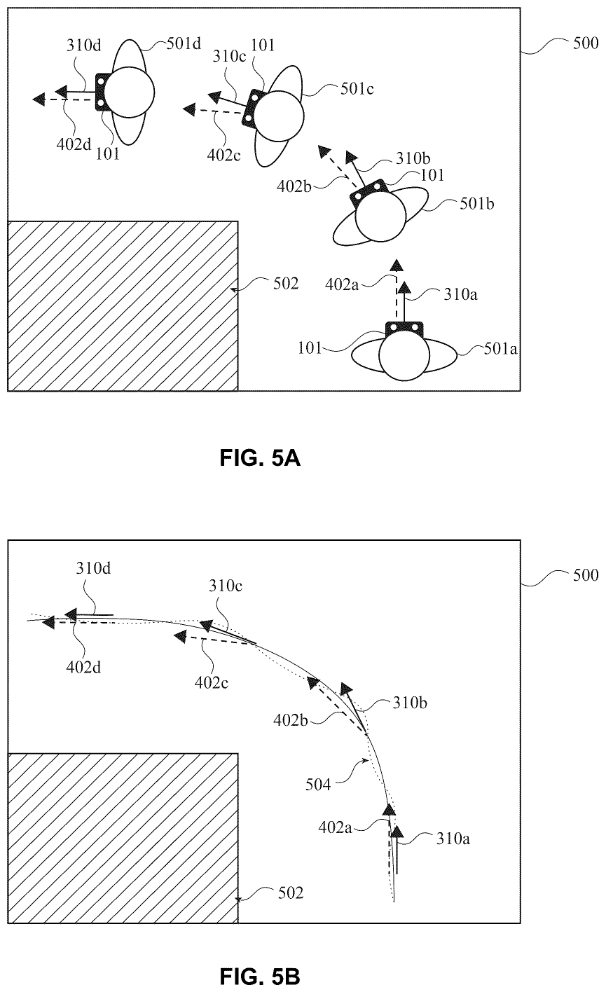

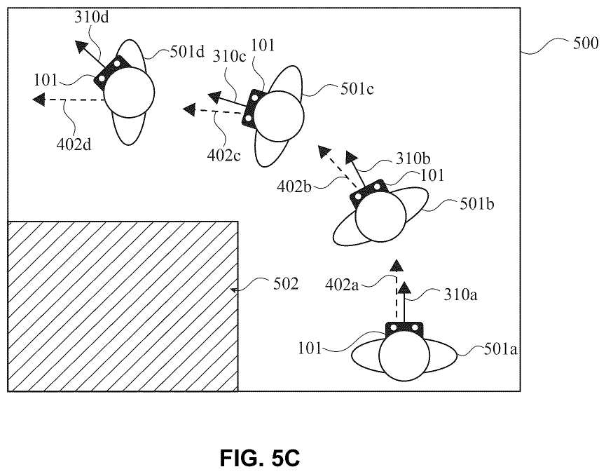

In some examples, electronic device 101 also tracks a second vector 402, different from the first vector 310, using the one or more input devices. The second vector 402 is indicative of a predicted motion path of the electronic device 101. The predicted motion path of the electronic device 101 corresponds to a prediction of a direction in which user 401 will move next (e.g., within a threshold amount of time of the current time, such as 0.05, 0.15, 0.25, 0.5, 1, 2, 5, etc. second in the future). In a non-limiting example, a head-mounted device uses a camera, or general tracking capabilities, to capture a motion path of user 401 and, based on the captured motion path, predict what direction user 401 may be moving in next. In some examples, to track the predicted motion, previous position frames of user 401 moving relative to the three-dimensional environment 300 as detected by electronic device 101 (e.g., the user's previous path of motion) are extrapolated and applied to the current frame of motion of the electronic device 101 (e.g., a user's current path of motion). More information about how the predicted motion vector, or second vector 402, is tracked is provided below in relation to FIG. 5A. In some examples, both the first vector 310 and second vector 402 have the same origin (e.g., reference point). For example, in FIGS. 4A and 4B, both the first vector 310 indicative of the orientation of the electronic device 101 and the second vector 402 indicative of predicted motion originate from the center of the head of user 401 (e.g., a center of the viewpoint of the electronic device 101). In some examples, the origin of both vectors is the center of mass of user 401. Furthermore, in some examples, a vector encoder is used to generate first vector 310 and second vector 402. In some examples, both vectors can be tracked using accelerometers, cameras, or anything similar.

The tracking of a predicted motion of user 401 enables electronic device 101 to compare the second vector 402 to the first vector 310 indicative of an orientation of the electronic device 101. For example, as shown in FIGS. 4A and 4B, the second vector 402 indicative of a predicted motion path of the electronic device 101 is shown. In both scenarios, user 401 is moving consistently along a straight path, so the second vector 402 is pointing in the direction of movement. In FIG. 4A, the first vector 310 and second vector 402 are facing the same direction, indicating that the head of user 401 is facing the same direction in which the body of the user 301 is moving. In FIG. 4B, on the other hand, the first vector 310 and second vector 402 have a directional difference in yaw (e.g., vector differences 404 and 406) because user 401 is moving in one direction, but their head is turning/facing another direction, different than the predicted motion path. Vector differences 404 and 406 represent the difference in yaw between first vector 310 and second vector 402, where vector difference 404 in FIG. 4A shows a small, almost nonexistent change in yaw compared to the larger change (e.g., wider distance between vectors) represented by vector difference 406 in FIG. 4B.

In some examples, electronic device 101 detects a difference between first vector 310 and second vector 402. This difference is illustrated by vector differences 404 and 406 shown in the figures. The difference occurs when first vector 310 and second vector 402 are pointing in different directions. In some examples, the difference is an angular distance between the vectors in the yaw direction. In another example, the difference includes a locational difference between first vector 310 and second vector 402 relative to display 120 (e.g., relative to a center of the display 120). For example, in FIG. 4A, the first vector 310 and second vector 402 have been individualized to emphasize that because user 401 is moving in the same direction their head faces, no difference between the first vector 310 and second vector 402 is detected. However, in FIG. 4B, shown are the first vector 310 and second vector 402 with a clear angular (e.g., directional) difference 406 between them due to the head rotation, as marked by the arc creating an angle measurement between them.

In some examples, detection of the difference between first vector 310 and second vector 402 occurs when a movement of the viewpoint of the electronic device 101 is detected. A viewpoint of the electronic device 101 (e.g., and thus the viewpoint of the user 401) determines what content is visible on the display 120, and generally specifies a location and a direction relative to the three-dimensional environment 300. The viewpoint of each user described herein has an accompanying viewpoint shown via display 120. As the viewpoint shifts, the view of the three-dimensional environment will also shift on display 120. In some examples, this shift in viewpoint of the electronic device 101 is indicative of a head rotation, and optionally results detection of a difference between first vector 310 and second vector 402. In some examples, a difference between first vector 310 and second vector 402 is detected when the difference exceeds a threshold difference. In some examples, the difference between first vector 310 and second vector 402 indicates that user 401 has rotated their head, because detected head orientation (e.g., indicated by the first vector 310) no longer aligns with their predicted motion path (e.g., indicated by the second vector 402).

In some examples, electronic device 101 determines the difference between first vector 310 and second vector 402 as a head rotation caused by the user turning their neck relative to the torso when one or more first criteria are satisfied. The one or more first criteria are conditions that must be satisfied for electronic device 101 to confirm the determined difference between vectors corresponds to a head rotation of user 401 and not an incidental head movement (e.g., a head jolt or jerk) or a rotation of the user's body (e.g., head and torso). In some examples, the one or more first criteria include a criterion that is satisfied when there is a yaw shift in viewpoint corresponding to rotation by a threshold amount, such as a threshold angle. In some examples, the threshold angle is a yaw angle threshold. In some examples, the one or more first criteria include a criterion that is satisfied when the threshold difference in first vector 310 and second vector 402 is detected associated with a specific period of time (e.g., to filter out head rotation that is too fast or too slow). In some examples, the one or more first criteria include a criterion that is satisfied when the difference between first vector 310 and second vector 402 indicates a speed that is greater than a speed threshold (e.g., angular velocity). In some examples, the one or more first criteria include evaluation of a time threshold, angular velocity threshold, distance threshold, an angle threshold, an acceleration threshold or any other suitable measurement to differentiate between non-intended and intended head movement. The threshold values are optionally determined at electronic device 101 (e.g., at calibration, at manufacture, etc.) or are set for the electronic device 101 by user 401 (or other user or developer), manually or based on a user calibration.

When the one or more first criteria are satisfied, then electronic device 101 determines the difference as a head rotation input. A head rotation input to an electronic device 101 can cause an action in accordance with the rotation of the user's head. In some examples, similar to a touch input or a button input, a head rotation input causes or provides an indication to the electronic device 101 to perform an operation. As non-limiting examples, a head rotation input can cause scrolling (e.g., vertical scrolling of a user interface using pitch rotation, horizontal scrolling of a user interface using yaw rotation), selection or cancelation (e.g., upward or downward pitch rotation), rotation (e.g., in accordance with a roll input, among other possibilities. In some examples, the head rotation input causes electronic device 101 to execute different actions on display 120. As described herein, some of the actions can control displayed user interfaces, but other actions can be independent of a displayed user interface (e.g., volume adjustment, playback controls for media, etc.). In some examples, when the one or more first criteria are not satisfied, electronic device 101 does not detect the difference between first vector 310 and second vector 402 to be a head rotation.

For example, FIG. 4A illustrates an example of the one or more first criteria not being satisfied. In this example, the difference between the first vector 310 and second vector 402 is less than the threshold angle or the first vector 310 and second vector 402 are parallel (e.g., within a threshold offset, such as 1 degree, 5 degrees, etc., when not the same directions). Thus, the angular yaw difference between first vector 310 and second vector 402 is less than the threshold angle and fails to satisfy at least this criterion (and thereby fails to satisfy the one or more first criteria). Thus, electronic device 101 determines that the difference does not correspond to a head rotation of user 401, and no head rotation input is detected. When a head rotation input is not detected, then the electronic device forgoes performing an action associate with a head rotation input.

Examples of the one or more first criteria not being satisfied include, without limitation, a shift in viewpoint not satisfying a threshold (e.g., less than the threshold angular rotation in the yaw direction relative to the difference between first vector 310 and second vector 402), a specific period of time of the head rotation not satisfying a minimum threshold time (e.g., the head rotation is too quick or too slow to be determined as intentional, such as a quick look in another direction or small, quick head shakes), a detection that more head movement is detected in arbitrary directions (e.g., head movements in the pitch and roll directions and/or off axis rotations detected with more magnitude than the yaw direction), or failure to satisfy another suitable criterion. For example, when the threshold angular rotation in the yaw direction relative to the difference between first vector 310 and second vector 402 is smaller than a threshold value of 5 degrees, then the one or more first criteria are not satisfied. In some examples, when the threshold angular rotation in the yaw direction relative to the difference between first vector 310 and second vector 402 is greater than a threshold value of 5 degrees, then the one or more first criteria are satisfied. As another example, when electronic device 101 detects erratic head movement, such as rapid accelerations, movement in multiple or opposite directions within a short period of time, a criterion of the one or more criteria is optionally not satisfied. In some examples, when the electronic device 101 detects a movement signature of deliberate head movement without the erratic movements, a criterion of the one or more criteria is optionally satisfied. In some examples, as described herein, not detecting a head rotation input refers to not detecting specific inputs and/or not performing corresponding actions on electronic device 101 based on head rotation. For example, although no head rotation input is detected for specifically performing an operation at the electronic device 101, head rotation of user 301 is still generally (e.g., passively) detected for various purposes on electronic device 101, such as minor changes to viewpoint associated with the display, keeping content in a particular locking configuration, etc.

Unlike FIG. 4A, FIG. 4B illustrates an example in which the one or more first criteria are satisfied. Specifically, a criterion of the one or more first criteria is satisfied when a difference between first vector 310 and second vector 402 is greater than the angle threshold. In this example, the directional difference between first vector 310 and second vector 402 is visibly wider, and the angular yaw difference is greater than the threshold angle value (e.g., 15 degrees, 30 degrees, 45 degrees, etc.). Thus, electronic device 101 determines that the difference corresponds to a head rotation of user 401 and a head rotation input is detected. Because the one or more first criteria are satisfied, including the criterion that is satisfied because the difference between first vector 310 and second vector 402 is greater than the threshold angle value, the head rotation input is detected and causes the electronic device to perform an action associated with the head rotation input.

In some examples, the one or more first criteria being satisfied includes, without limitation, a shift in viewpoint exceeding a certain threshold distance, a specific period of time of the head rotation exceeding a minimum threshold time, a detection that no more head movement is detected in arbitrary directions (e.g., one sharp head movement and no little random movements), or anything similar. Furthermore, in some examples, the one or more first criteria include a criterion that is satisfied when an angular velocity is greater than an angular velocity threshold.

In some examples, one or more first criteria include a criterion that is based on whether the difference between first vector 310 and second vector 402 is indicative of a user traveling around a corner or curve. In FIGS. 5A-5C, illustrated is a progression of a user of the electronic device 101 in motion and traveling around a corner 502 in three-dimensional environment 500. In FIG. 5A, user of the electronic device 101 moves their head as they turn the corner, but the user's head stays roughly in the same positon/orientation in relation to their body, so a head rotation input is not detected. FIG. 5B shows the travel curve indicative of the predicted motion path from FIG. 5A with both the actual motion path 504 and the predicted motion path shown (e.g., in solid line). In FIG. 5C, the user of the electronic device 101 moves their head as they turn the corner, such that the electronic device 101 detects a head rotation at the end of the travel curve.

In some examples, electronic device 101 tracks the vectors while the user travels around a corner or curve. When moving on a curved path, a user's head and body (e.g., torso) both turn in the same direction over a period of time, which results in the head rotation not being detected as a head rotation input (e.g., because the one or more first criteria are not satisfied). Rather than a head rotation, the movement is due to motion/locomotion of the user in three-dimensional environment 500. As shown in FIG. 5A, snapshots of user of the electronic device 101 (e.g., user 501a, user 501b, user 501c, and user 501d) can be seen as they travel around corner 502 in three-dimensional environment 500 while wearing electronic device 101. User 501a represents the starting position of user of the electronic device 101 and user 501d represents the final position of user 501; because the head of user of the electronic device 101 begins and ends in the same position, no difference between first vector 310 and second vector 402 is determined and thus no head rotation input is detected.

In some examples, the predicted motion vector, or second vector 402, accounts for the unintentional head rotation due to the movement relative to the prior forward vector of the head-mounted device. In some examples, second vector 402 can predict and/or detect when user of the electronic device 101 is traveling around corner 502. As shown in FIG. 5B, a dotted line representing the actual motion path 504 of user of the electronic device 101 is exemplified against the predicted motion path of user of the electronic device 101 represented by the solid line/curve and tracked by second vector 402. As user of the electronic device 101 begins to travel around corner 502, the predicted motion path includes second vector 402 pointing in a direction coinciding with the curved path. In some examples, electronic device 101 has one or more cameras to help track actual motion path 504 around corner 502. For example, to track the predicted motion path, past frames of the user's actual motion path 504 is extrapolated and applied to the current frame of motion, which is then used to predict the next frame of motion. This predicted curved motion is then used and compared to the head orientation of user 501, corresponding to first vector 310. Because electronic device 101 is configured to detect that user of the electronic device 101 is traveling on a curved path and/or around a corner 502, and because user of the electronic device 101 initiated and ceased traveling in the same orientation relative to the predicted motion path, the one or more first criteria are not met; thus, no head rotation input is detected.

In some examples, differences between first vector 310 and second vector 402 occur when user of the electronic device 101 is detected going around a corner or curve, as shown at each snapshot/position of user of the electronic device 101 in FIGS. 5A-5C. In some examples, the tangent of the travel curve is measured to determine how much user of the electronic device 101 has rotated their body. For example, when corner 502 or the curve that user of the electronic device 101 travels is wide, the predicted travel curve (e.g., long solid line in FIG. 5B) will be a long sweeping tail. In some examples, the one or more first criteria may include a criterion that is satisfied when the slope of the travel curve meets or exceeds a threshold slope. Furthermore, in some examples, electronic device 101 begins to measure a travel curve of user of the electronic device 101 when the display of electronic device 101 begins to shift in viewpoint. In some examples, electronic device 101 tracks the travel curve continuously. In some examples, electronic device 101 tracks the curve when locomotion is detected (e.g., user is walking), and ceases tracking when locomotion ceases (e.g., user is standing still or sitting).

In some examples, no head rotation input is detected as user of the electronic device 101 travels around a corner or curve because of a criterion that is based on a specific period of time of the head rotation was not satisfied. In some examples, the one or more first criteria may include a criterion that is satisfied when the period of time of the head rotation movement is less than a time period threshold value. In some examples, the one or more criteria include a criterion that is satisfied when the position of the user's head relative to the orientation of their body has changed. In some examples, the one or more first criteria may include a criterion that is satisfied when the velocity of user of the electronic device 101 is more than a velocity threshold. In some examples, the one or more first criteria may include a criterion that is satisfied when the acceleration of user of the electronic device 101 is more than an acceleration threshold. For example, when a threshold velocity to satisfy the criterion is 5 mph, and the user of the electronic device 101 is traveling 4 mph, then no head rotation input is detected. Furthermore, when a threshold velocity to satisfy the criterion is 5 mph, and the user of the electronic device 101 is traveling 10 mph, then a head rotation input is detected.

FIG. 5C show is an example of head rotation input. Because the user's head orientation is different in the final position of user of the electronic device 101 (e.g., represented by user 501d) compared to the initial position, or prior position, of user of the electronic device 101 (e.g., represented by user 501a), the one or more first criteria are satisfied. In some examples, when the one or more first criteria are satisfied, including a criterion based on a difference between vectors 310d and 402d, the electronic device 101 detects a head rotation input.

In some examples, the electronic device 101 presents a user interface that is interactable via the head rotation input. The user interface is displayed via the one or more displays on the electronic device and any be any user interface or computing device described herein. In some examples, determining whether the one or more first criteria are satisfied occurs while presenting the user interface of the electronic device. Further, in some examples, the action includes interacting with the user interface using the head rotation input as an input to the user interface.

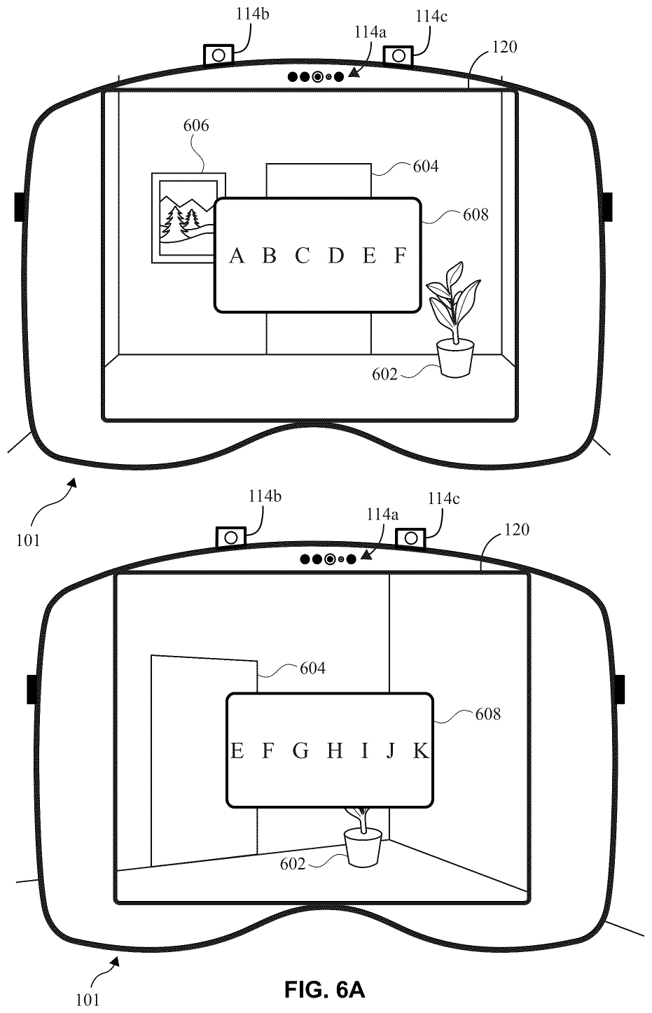

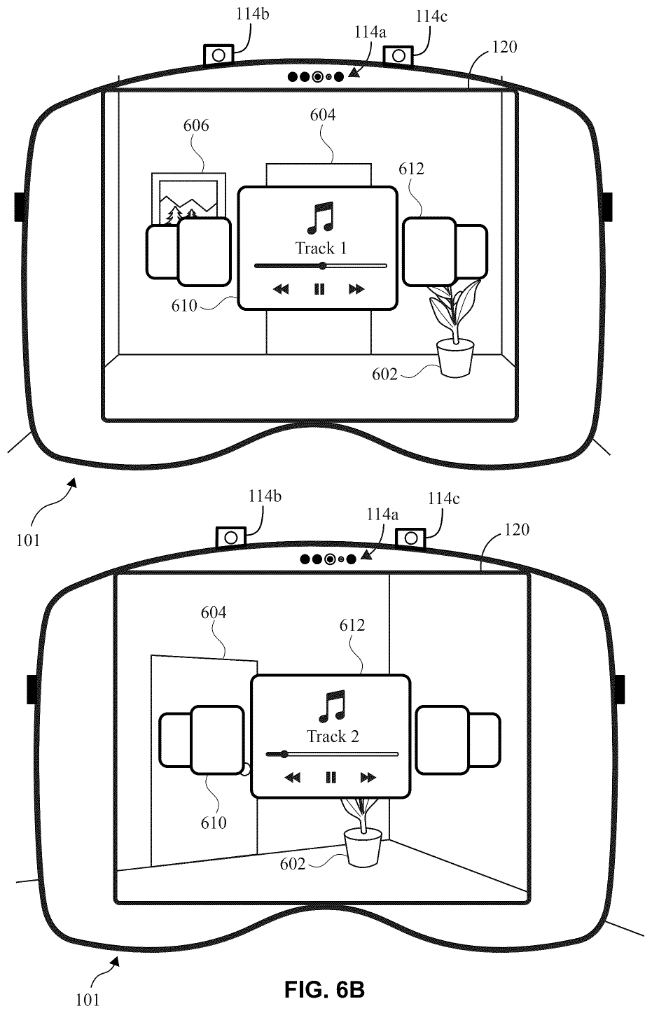

In some examples, when the difference between vectors is determined to correspond to a head rotation, electronic device 101 performs an action in accordance with the head rotation input satisfying one or more second criteria on the user interface. Performing an action on electronic device 101 includes any action that causes a change to or in the display of a user interface or user interface element via the display 120 of electronic device 101. In some examples, without limitation, performing the action includes, scrolling contents on display 120, moving a digital object displayed on display 120, changing the audio track that is playing on electronic device 101, selecting an icon displayed on display 120, changing which application on electronic device 101 is being displayed, exiting out of an application, turning off electronic device 101, or anything similar. For example, FIGS. 6A and 6B show example actions that are performed on electronic device 101 when the head rotation input is detected and meets the one or more second criteria. However, the action will not be performed when the difference between vectors is not determined to be a head rotation input, or when the head rotation input does not satisfy the one or more second criteria. In some examples, when the difference is determined to not be a head rotation, electronic device 101 forgoes performing the action.

In some examples, the one or more second criteria must be satisfied in order to perform the action on display 120 of electronic device 101. In some examples, the one or more first criteria must be satisfied in order for electronic device 101 to determine if the head movement was a head rotation input, and the one or more second criteria must be satisfied in order for the electronic device 101 to perform an action in response to the detected head rotation input. One or more second criteria may be included in the one or more first criteria described herein, however the head rotation input must satisfy these criteria to perform an action on display 120. For example, satisfaction of the one or more second criteria requires that the one or more first criteria are satisfied, but satisfaction of the one or more first criteria does not require that the one or more second criteria are satisfied. In some examples, the one or more second criteria include a criterion that is satisfied when the difference between the first vector 310 and the second vector 402 is greater than the threshold. For example, the one or more second criteria include a criterion that is satisfied when an angular velocity is greater than an angular velocity threshold. In some examples, the one or more second criteria include a criterion that is satisfied when the detected head rotation input, or difference between vectors, meets a minimum yaw rotation threshold value. In another example, without limitation, the one or more second criteria include a criterion that is satisfied when the head rotation input meets a minimum time threshold value. Further, another example includes a criterion that is satisfied when the head rotation input is detected as rotation in a specific direction (e.g., a head rotation to the left or a head rotation to the right in the yaw direction).

In some examples, electronic device 101 prompts, using one or more of audio, visual, and/or haptic output devices, the user for confirmation of the head rotation input, wherein performing the action is also in accordance with the confirmation being received. In some examples, the user receives a pop-up indication on display 120 asking if a head rotation input was intentionally performed. User input (e.g., touch, air gestures, or verbal command, among other options) are provided by the user to confirm. In some other examples, audio is played by the one or more audio output devices or a haptic is output by the one or more haptic output devices of electronic device 101 to alert the user of a need for confirmation of a head rotation input. In some examples, this confirmation is a criterion of the one or more second criterion that is satisfied when the confirmation input is received in order to perform the action.

FIGS. 6A and 6B show example actions that can be performed on the electronic device 101 as a result of the head rotation input. The top electronic device 101 in the figures represents the display 120 before performing the action, while the bottom electronic device 101 shows display 120 after the action is performed.

In FIG. 6A, the top display 120 shows scrollable content 608 in the three-dimensional environment of electronic device 101. When a head rotation input is determined and satisfies the one or more second criteria, then the scrollable content 608 (e.g., the alphabet) will be scrolled, or shifted, in the same direction of head rotation input. For example, when the user interface displays an alphabetized, horizontal list, a head rotation movement to the right in the yaw direction can lead to the performance of scrolling the list to the left, as shown in the bottom display 120 of electronic device 101 in FIG. 6A.

In FIG. 6B, the top display 120 shows a media application in the three-dimensional environment of electronic device 101. The media application includes any sort of media application including, but without limitation, a music application, a video application, a podcast application, a television application, or anything similar. In some examples, the action performed by the electronic device 101 includes changing playback from a first media item to a second media item, different from the first media item, or from a first playback position within the first media item to a second playback position, different from the first playback position, within the first media item. As shown, for example, the media (e.g., music) application currently plays a first media item 610 (e.g., a musical track). When a head rotation input is detected and satisfies the one or more second criteria, then the electronic device 101 will change first media item 610 to the second media item 612. The manner in which the media item is changed optionally depends on the direction of head rotation input. For example, when the display 120 presents first media item 610 in FIG. 6A, and a head rotation movement to the right yaw direction is detected, then the electronic device 101 performs the action of switching to playing and displaying second media item 612, as shown in the bottom user interface of FIG. 6B. In some examples, when the head rotation movement is detected in the left yaw direction, the user interface will change the media item of a musical track to the previously played musical track/media item (e.g., will display and initiate playback of a media item spatially located to the left of the first media item 610 from the viewpoint of the electronic device 101).

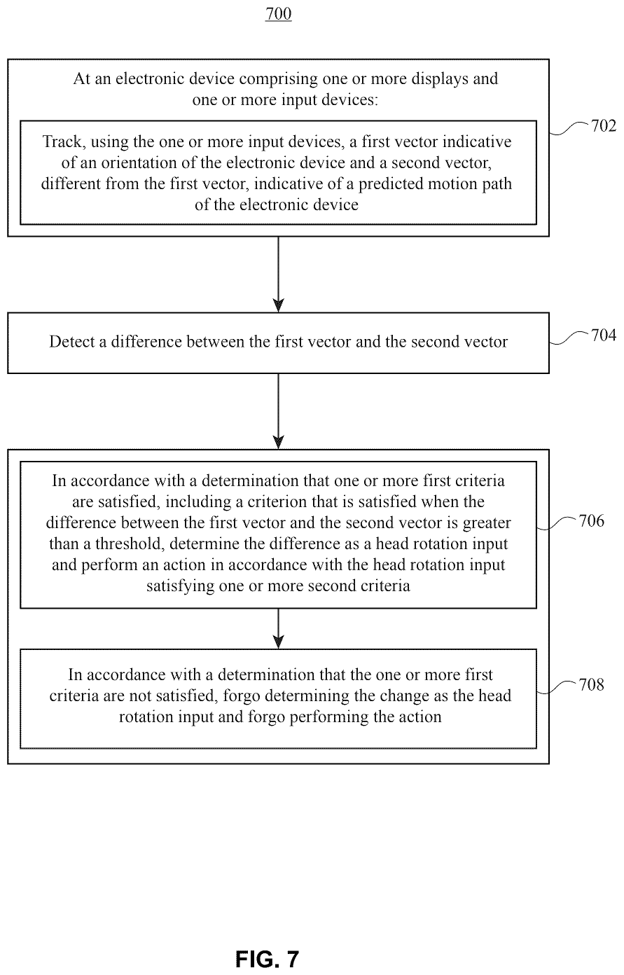

FIG. 7 illustrates a flow diagram illustrating an example process for head rotation determination based on route tracing according to some examples of the disclosure. In some examples, process 700 begins at an electronic device in communication with one or more displays and one or more input devices. In some examples, the electronic device is optionally a head-mounted display similar or corresponding to an electronic device (e.g., electronic device 101 of FIG. 1 and electronic device 260 of FIG. 2). As shown in FIG. 7, in some examples, at 702, the electronic device (e.g., electronic device 101) tracks, using the one or more input devices, a first vector (e.g., first vector 310 in FIG. 3A) indicative of an orientation of the electronic device and a second vector (e.g., second vector 402 in FIG. 4A), different from the first vector, indicative of a predicted motion path of the electronic device. In some examples, the first vector is indicative of a forward direction of the electronic device. In some examples, tracking the second vector includes determining a predicted motion path using a plurality of positions, as shown in FIGS. 5A-5C. In some examples, at 704, the electronic device detects a difference between first vector and second vector. For example, as shown in FIG. 4B, an angular difference (e.g., vector differences 404 and 406 of FIGS. 4A-4B) between first vector and second vector is shown. In some examples, the difference between the first vector and the second vector is detected along the yaw axis. In some examples, this difference helps determine when a user intentionally rotated their head or not. Referring still to FIG. 7, in some examples, at 706, in accordance with a determination that one or more first criteria are satisfied, including a criterion that is satisfied when the difference between the first vector and the second vector is greater than a threshold, determining the difference as a head rotation input. In some examples, the criterion is not satisfied when the difference between the first vector and the second vector is less than or equal to the threshold, wherein the threshold is ana angular yaw threshold. In some examples, one or more first criteria include a criterion that is satisfied when an angular velocity is greater than an angular velocity threshold.

Still referring to FIG. 7, in some examples, at 706, when the different is determined to be a head rotation input, the electronic device performs an action in accordance with the head rotation input satisfying one or more second criteria, as shown in FIGS. 6A-6B. In some examples, the one or more second criteria include a criterion that is satisfied when the difference between the first vector and the second vector is greater than the threshold and/or a criterion that is satisfied when an angular velocity is greater than an angular velocity threshold. In some examples, at 708, in accordance with a determination that the one or more first criteria are not satisfied, forgoing determining the difference as the head rotation input and forgoing performing the action. In some examples, the action is changing playback from a first media item to a second media item, different from the first media item, or from a first playback position within the first media item to a second playback position, different from the first playback position, within the first media item, as shown in FIG. 6B. In some examples, the action includes scrolling content of a user interface on the display, as shown in FIG. 6A. Lastly, process 700, in some examples, includes electronic device prompting, using one or more of audio, visual, or haptic output devices, the user for confirmation of the head rotation input, wherein performing the action is also in accordance with the confirmation being received.

It is understood that process 700 is an example, and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

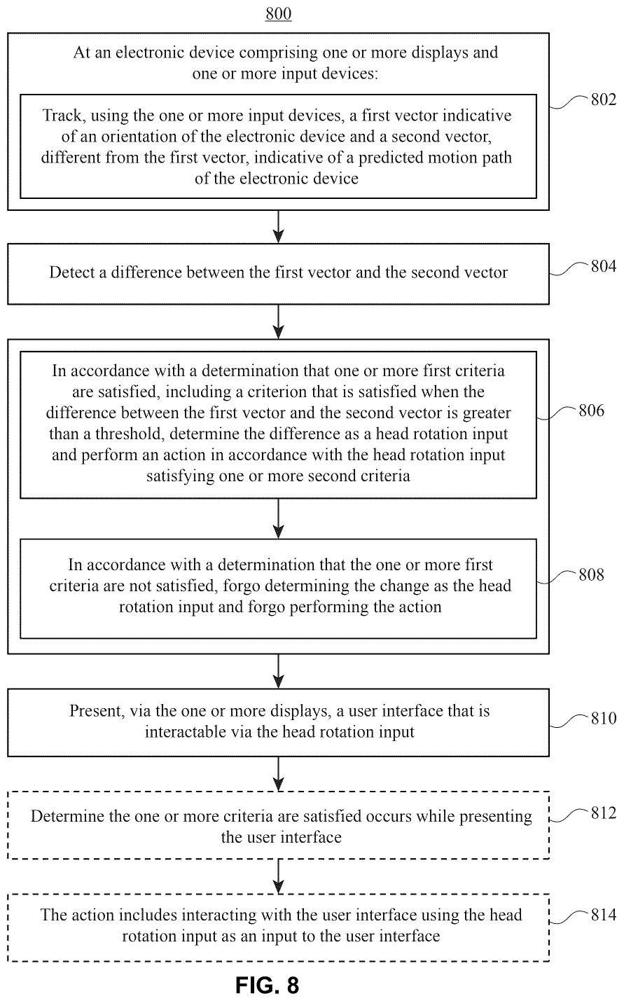

FIG. 8 illustrates a flow diagram illustrating an example process for head rotation determination based on route tracing according to some examples of the disclosure. In some examples, process 800 begins at an electronic device in communication with one or more displays and one or more input devices. In some examples, the electronic device is optionally a head-mounted display similar or corresponding to an electronic device (e.g., electronic device 101 of FIG. 1 and electronic device 260 of FIG. 2). As shown in FIG. 8, in some examples, steps 802-808 of process 800 are the same as steps 702-708 of process 700. However, process 800 incudes in few more steps. In some examples, at 810, electronic device presents, via the one or more displays, a user interface that is interactable via the head rotation input. In some examples, at 812, wherein when determining the one or more first criteria are satisfied occurs while presenting the user interface. Lastly, in some examples and shown in FIGS. 6A-6B, the action includes interacting with the user interface using the head rotation input as an input to the user interface.

It is understood that process 800 is an example, and that more, fewer, or different operations can be performed in the same or in a different order. Additionally, the operations in process 800 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method. The method comprising, at an electronic device comprising one or more displays and one or more input devices: tracking, using the one or more input devices, a first vector indicative of an orientation of the electronic device and a second vector, different from the first vector, indicative of a predicted motion path of the electronic device; in accordance with a determination that one or more first criteria are satisfied, including a criterion that is satisfied when a difference between the first vector and the second vector is greater than a threshold, determining the difference as a head rotation input and performing an action in accordance with the head rotation input; and in accordance with a determination that the one or more first criteria are not satisfied, forgoing determining the difference as the head rotation input and forgoing performing the action.

Additionally or alternatively, in some examples, the method further comprises presenting, via the one or more displays, a user interface that is interactable via the head rotation input. Determining the one or more first criteria are satisfied occurs while presenting the user interface. The action includes interacting with the user interface using the head rotation input as an input to the user interface. Additionally or alternatively, in some examples, the first vector is indicative of a forward direction of the electronic device. Additionally or alternatively, in some examples, tracking the second vector includes determining a predicted motion path using a plurality of positions. Additionally or alternatively, in some examples, the difference between the first vector and the second vector is detected along a yaw axis. Additionally or alternatively, in some examples, the criterion is not satisfied when the difference between the first vector and the second vector is less than or equal to the threshold. Additionally or alternatively, in some examples, the threshold is an angular yaw threshold. Additionally or alternatively, in some examples, the one or more first criteria include a criterion that is satisfied when an angular velocity is greater than an angular velocity threshold. Additionally or alternatively, in some examples, the action is changing playback from a first media item to a second media item, different from the first media item, or from a first playback position within the first media item to a second playback position, different from the first playback position, within the first media item. Additionally or alternatively, in some examples, the action includes scrolling content of a user interface on the one or more displays. Additionally or alternatively, in some examples, the method further comprises prompting, using one or more of audio, visual, or haptic output devices, a user for confirmation of the head rotation input. Performing the action is also in accordance with the confirmation being received.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed is:

1. A method comprising:
at an electronic device comprising one or more displays and one or more input devices:
determining, using the one or more input devices, a first vector indicative of an orientation of the electronic device and a second vector, different from the first vector, indicative of a predicted motion path of the electronic device;
in accordance with a determination that one or more first criteria are satisfied, including a criterion that is satisfied when a difference between the first vector and the second vector is greater than a threshold, determining the difference as a head rotation input and performing an action in accordance with the head rotation input satisfying one or more second criteria; and
in accordance with a determination that the one or more first criteria are not satisfied, forgoing determining the difference as the head rotation input and forgoing performing the action.

2. The method of claim 1, further comprising:
presenting, via the one or more displays, a user interface that is interactable via the head rotation input, wherein determining the one or more first criteria are satisfied occurs while presenting the user interface, and the action includes interacting with the user interface using the head rotation input as an input to the user interface.

3. The method of claim 1, wherein the first vector is indicative of a forward direction of the electronic device.

4. The method of claim 1, wherein determining the second vector includes determining a predicted motion path using a plurality of positions.

5. The method of claim 1, wherein the criterion is not satisfied when the difference between the first vector and the second vector is less than or equal to the threshold.

6. The method of claim 1, wherein the one or more first criteria include a criterion that is satisfied when an angular velocity of the electronic device is greater than an angular velocity threshold.

7. The method of claim 1, further comprising:
prompting, using one or more of audio, visual, or haptic output devices, a user for confirmation of the head rotation input, wherein performing the action is also in accordance with the confirmation being received.

8. The method of claim 1, wherein the one or more second criteria include a criterion that is satisfied when the head rotation input is at least a yaw rotation threshold value.

9. An electronic device, comprising:
one or more displays;
one or more input devices;
one or more processors;
memory; and
one or more programs, wherein the one or more programs are stored in the memory and configured to be executed by the one or more processors, the one or more programs including instructions for:
determining, using the one or more input devices, a first vector indicative of an orientation of the electronic device and a second vector, different from the first vector, indicative of a predicted motion path of the electronic device;
in accordance with a determination that one or more first criteria are satisfied, including a criterion that is satisfied when a difference between the first vector and the second vector is greater than a threshold, determining the difference as a head rotation input and performing an action in accordance with the head rotation input satisfying one or more second criteria; and
in accordance with a determination that the one or more first criteria are not satisfied, forgoing determining the difference as the head rotation input and forgoing performing the action.

10. The electronic device of claim 9, the one or more programs further including instructions for:
presenting, via the one or more displays, a user interface that is interactable via the head rotation input, wherein determining the one or more first criteria are satisfied occurs while presenting the user interface, and the action includes interacting with the user interface using the head rotation input as an input to the user interface.

11. The electronic device of claim 9, wherein the first vector is indicative of a forward direction of the electronic device.

12. The electronic device of claim 9, wherein determining the second vector includes determining a predicted motion path using a plurality of positions.

13. The electronic device of claim 9, wherein the criterion is not satisfied when the difference between the first vector and the second vector is less than or equal to the threshold.

14. The electronic device of claim 9, wherein the one or more first criteria include a criterion that is satisfied when an angular velocity of the electronic device is greater than an angular velocity threshold.

15. The electronic device of claim 9, the one or more programs further including instructions for:
prompting, using one or more of audio, visual, or haptic output devices, a user for confirmation of the head rotation input, wherein performing the action is also in accordance with the confirmation being received.

16. The electronic device of claim 9, wherein the one or more second criteria include a criterion that is satisfied when the head rotation input is at least a yaw rotation threshold value.

17. A non-transitory computer-readable storage medium storing one or more programs, the one or more programs comprising instructions, which, when executed by an electronic device with one or more displays and one or more input devices, cause the electronic device to perform:
determining, using the one or more input devices, a first vector indicative of an orientation of the electronic device and a second vector, different from the first vector, indicative of a predicted motion path of the electronic device;
in accordance with a determination that one or more first criteria are satisfied, including a criterion that is satisfied when a difference between the first vector and the second vector is greater than a threshold, determining the difference as a head rotation input and performing an action in accordance with the head rotation input satisfying one or more second criteria; and
in accordance with a determination that the one or more first criteria are not satisfied, forgoing determining the difference as the head rotation input and forgoing performing the action.

18. The non-transitory computer-readable storage medium of claim 17, the instructions further cause the electronic device to:
presenting, via the one or more displays, a user interface that is interactable via the head rotation input, wherein determining the one or more first criteria are satisfied occurs while presenting the user interface, and the action includes interacting with the user interface using the head rotation input as an input to the user interface.

19. The non-transitory computer-readable storage medium of claim 17, wherein the first vector is indicative of a forward direction of the electronic device.

20. The non-transitory computer-readable storage medium of claim 17, wherein determining the second vector includes determining a predicted motion path using a plurality of positions.

21. The non-transitory computer-readable storage medium of claim 17, wherein the criterion is not satisfied when the difference between the first vector and the second vector is less than or equal to the threshold.

22. The non-transitory computer-readable storage medium of claim 17, wherein the one or more first criteria include a criterion that is satisfied when an angular velocity of the electronic device is greater than an angular velocity threshold.

23. The non-transitory computer-readable storage medium of claim 17, the instructions further cause the electronic device to:
prompting, using one or more of audio, visual, or haptic output devices, a user for confirmation of the head rotation input, wherein performing the action is also in accordance with the confirmation being received.

24. The non-transitory computer-readable storage medium of claim 17, wherein the one or more second criteria include a criterion that is satisfied when the head rotation input is at least a yaw rotation threshold value.
